(19) United States
(12) Patent Application Publication
(10) Pub. No.: US 2018/0376268 A1
(43) Pub. Date: Dec. 27, 2018

(54) APPARATUS AND METHOD FOR DETECTING LOUDSPEAKER CONNECTION OR POSITIONING ERRORS DURING CALIBRATION OF A MULTICHANNEL AUDIO SYSTEM

(71) Applicant: THOMSON Licensing, Issy-les-Moulineaux (FR)

(72) Inventors: Michel KERDRANVAT, Chantepie (FR); Christophe COCAULT, MORDELLES (FR); Eric ZABRE, CLAYES (FR)

(21) Appl. No.: 16/063,547

(22) PCT Filed: Dec. 9, 2016
(86) PCT No.: PCT/EP2016/080367

§ 371 Date: Jun. 18, 2018

(30) Foreign Application Priority Data
Dec. 18, 2015 (EP) 15307057.8

(51) Int. Cl. H04R 29/00; H04R 5/04; H04S 7/00; H04R 3/12; H04R 5/02

(52) U.S. Cl. CPC H04R 29/002; H04R 5/04; H04S 7/30; H04R 2499/15; H04R 5/02; H04R 2420/05; H04S 2400/01; H04R 3/12

(57) ABSTRACT

A method and an apparatus for detecting loudspeaker connection errors and positioning errors during calibration of a multichannel audio system to which a plurality of loudspeakers is connected. Within a calibration process of a multichannel audio system, the loudspeaker whose angle is to be measured is identified by emitting a test tone (451) and verifying (460) the conformance between angles measured and a range of acceptable angles for each loudspeaker. A positioning error is detected when the measured angle is not included in the range of acceptable angles but in the range of acceptable angles of the closest speaker. A connection error is detected when the measured angle is very different from the range of acceptable angles. In case of errors, a recommendation is expressed (470) to the user in order to make the appropriate corrections. A calibration device (100) and an audio processing device (120) implementing the method are disclosed.

### TECHNICAL FIELD

The present disclosure relates to the calibration of multichannel audio systems and more precisely describes a method for detecting loudspeaker connection errors and positioning errors during the calibration of a multichannel audio system to which a plurality of loudspeakers is connected.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A multichannel audio system is composed of an audio amplifier receiving an audio signal and a plurality of loudspeakers located at different places in the listening room, connected to the amplifier and allowing to render the sound. These systems became popular in households some years ago with the introduction of surround home theatre systems comprising an amplifier, a central loudspeaker, a loudspeaker positioned at the front left, a loudspeaker positioned at the front right, two loudspeakers positioned in the rear, behind the listener and one subwoofer loudspeaker dedicated to low frequencies that can be positioned almost anywhere in the room. The plurality of loudspeakers and their physical location deliver to the listener a feeling of spatial positioning of the sound. Such systems evolved towards more complex systems and in the near future it is considered to utilise much more loudspeakers, with the objective to reach a kind of three-dimensional sound allowing precise localization of the different sound sources.

Audio configurations are defined by the number of loudspeakers. A simple notation is used to identify the number and type of loudspeakers. In surround systems, the notation uses to digits separated by a point. A 2.1 system uses 2 loudspeakers at the front and one subwoofer. In more complex systems, three digits are used to identify the number of loudspeakers, the third digit indicates the number of speakers to be placed in height. For example, the future American Television Society Committee (ATSC 3.0) standard will target 7.1.4 audio system to provide a real immersive audio environment which means 4 speakers placed in height in addition to a 7.1 surround set-up. However sub systems such as 5.1.4 or 5.1.2 are also possible.

However, in order to have a correct perception of the sound localisation, a so-called calibration phase is required to set the different calibration parameters for each loudspeaker. The first calibration parameter considered is the delay. When a first loudspeaker is quite close to the listener, he/she will receive the sound earlier than the one coming from a second loudspeaker that is farther away. Therefore the delay for each loudspeaker needs to be set according to the distance to the listener so that the audio signal is perceived simultaneously from all loudspeakers at a listener position. A second parameter is the gain. Similar to the delay, the volume perceived by the user at the listener position is not homogeneous for all loudspeakers and depends on many parameters, including the distance but also the room configuration, the furniture in the room and materials of the walls, ceiling etc. that reflect some parts of the sound and absorb other parts. Therefore the gain for each loudspeaker needs to be adjusted so that the audio signal is perceived homogeneously from all loudspeakers at the listener position. With these delay and gain calibrations, the multichannel audio system is able to achieve a well-balanced sound with maximal effects at the listener position.

A number of different solutions allow the calibration of multichannel audio systems. A common technique is based on playing back a test signal successively on each loudspeaker and measure the sound values at the listener position using a microphone connected to the amplifier. Combined with the loudspeaker distance, the measured sound values allow to compute the settings (delay, gain) of calibration parameters to be applied to each loudspeaker. To get the distance value, the user either has to enter the distance between the loudspeakers and the listening position or to position the loudspeaker at a given distance. Another technique makes use of inertial sensors in the measurement device to measure the distance between loudspeakers and perform a kind of cartography of the room by placing successively the measurement device on each loudspeaker. However, this technique is cumbersome to apply and may even be difficult to apply in the case the listening room has high ceilings. Furthermore, these measurements are not very precise and prone to errors.

The calibration is essential for setting up the system but is only correct if the user didn't perform any mistake in wiring the loudspeakers. Wiring a small number of loudspeakers can be seen as an easy task, but very often the lack of experience of the users results in errors in this phase. With the increase of the number of speakers, the probability of errors increases also. Errors in positioning can have a huge negative impact on the final result. For example, if the rear loudspeakers are not positioned behind the listening position, the spatial effect will not be perceived correctly.

Patent application US2014/0270282A1 discloses a method related to loudspeaker positioning in a multi-speaker audio system, based on using spatial sound measurements with an array of microphones to determine the loudspeakers positions. Patent application WO2014/162171A1 discloses a visual audio processing apparatus that controls the characteristics of an audio source in a spatialized audio scene through visual image elements captured by a camera. Patent application WO2007/004134A2 discloses a method for controlling a plurality of devices, wherein the device to be controlled is selected according the direction given by a pointing device integrating a camera, the captured image being analysed to determine the position of the devices and which device the user is aiming at.

It can therefore be appreciated that there is a need for a solution for calibration of multichannel audio systems that addresses at least some of the problems of the prior art. The present disclosure provides such a solution.

### SUMMARY

The present disclosure is about a method and an apparatus for detecting loudspeaker connection errors and positioning errors during the calibration of a multichannel audio system to which a plurality of loudspeakers is connected.

A salient idea of the disclosure is, within a calibration process of a multichannel audio system, to identify the loudspeaker whose angle is to be measured by emitting a test tone. The conformance between angles measured and a range of acceptable angles is verified for each loudspeaker. A positioning error is detected when the measured angle is not included in the range of acceptable angles but in the range of acceptable angles of the closest speaker. A connection error is detected when the measured angle is very different from the range of acceptable angles. In case of errors, a recommendation is expressed to the user in order to make the appropriate corrections.

In a first aspect, the disclosure is directed to a method for detecting loudspeaker connection errors and positioning errors in a multichannel audio system composed of an audio processing device connected to a set of loudspeakers, comprising at a processor of a calibration device: for each loudspeaker, measuring at least one of the azimuth and elevation angles of the loudspeaker in a three-dimensional coordinate system when the test tone is played on the loudspeaker, verifying that the measured angles are comprised in a range of acceptable values for the loudspeaker, and in case at least one measured angle is outside the range of acceptable values for the loudspeaker, notifying the user of the error.

Various embodiments of first aspect comprise:
displaying on a screen of the calibration device at least an image captured by a camera of the calibration device, an overlaid picture indicating the aiming area and a message instructing the user to aim at the loudspeaker emitting the test tone; and obtaining validation from the user when the calibration device is aimed at the loudspeaker, aligning on the screen of the calibration device the overlaid picture with the captured image of the loudspeaker;
measuring the distance between a display device and a calibration device, comprising displaying on the screen of the calibration device at least the image captured by the camera of the calibration device, a picture indicating where the user should aim and a message instructing the user to target a first corner of the display device, obtaining validation from the user when pointing towards the first corner, measuring the azimuth and elevation angles of the first corner, displaying on the screen of the calibration device the image captured by the camera of the calibration device, a picture indicating where the user should aim and a message instructing the user to target the second corner of the display device, the corner opposite to the first one, obtaining validation from the user when pointing towards the second corner, measuring the azimuth and elevation angles of the second corner, computing the distance between the calibration device and the display device; and verifying that the computed distance is comprised in a range of acceptable distances for the system, and when it is not the case, notifying the user of the error.
displaying on the screen of the calibration device at least the image captured by the camera of the calibration device, a picture indicating where the user should aim and a message instructing the user to target the centre of the display device, displaying on the screen of the display device, at the centre of the screen, at least a picture indicating where the user should aim at, obtaining validation from the user when pointing towards the centre of the display device, measuring the azimuth and elevation angles of the centre of the display device and setting the azimuth and elevation angles of the centre of the display device as reference angles for further loudspeaker angle measurements.
verifying that the device is held in upright position, the verification comprising checking that the absolute value of the roll angle obtained from the sensors is below a threshold; and if the verification succeeds, enabling the user validation means, if the verification fails, disabling the user validation means and displaying indications to help recover the upright position.
displaying the message displayed on the screen of the calibration device also on the display device.

In a variant embodiment of the first aspect, the processor of the calibration device is configured to provide at least one of the azimuth and elevation angles to the processor of the audio processing device, configured to verify that the measured angles are comprised in a range of acceptable values for the loudspeaker, and in case at least one measured angle is outside the range of acceptable values for the loudspeaker, notify the user of the error.

In a second aspect, the disclosure is directed to a device for performing angular measurement of loudspeaker angular positions, verifications of these positions according to a range of acceptable positions and interactions with a user in a multichannel audio system, comprising a processor configured to, for each loudspeaker, measure at least one of the azimuth and elevation angles of the loudspeaker in a three-dimensional coordinate system when the test tone is played on the loudspeaker, verify that the measured angles are comprised in a range of acceptable values for the loudspeaker, and in case at least one measured angle is outside the range of acceptable values for the loudspeaker, notify the user of the error, a network interface configured to request a loudspeaker to play back a test tone, a screen configured to display at least the image captured by the camera, a picture indicating where the user should aim and a message instructing the user what element to target, a user input interface configured to obtain validation from the user when the calibration device is aimed at the loudspeaker, aligning on the screen of the calibration device the overlaid picture with the captured image of the loudspeaker, sensors configured to determine azimuth, elevation and roll angles of the device, and a camera configured to capture images representing a scene in front of the device.

Various embodiments of the second aspect comprise:
measuring the distance between a display device and a calibration device, comprising displaying on the screen of the calibration device at least the image captured by the camera of the calibration device, a picture indicating where the user should aim and a message instructing the user to target a first corner of the display device, obtaining validation from the user when pointing towards the first corner, measuring the azimuth and elevation angles of the first corner, displaying on the screen of the calibration device the image captured by the camera of the calibration device, a picture indicating where the user should aim and a message instructing the user to target the second corner of the display device, the corner opposite to the first one, obtaining validation from the user when pointing towards the second corner, measuring the azimuth and elevation angles of the second corner, computing the distance between the calibration device and the display device; and verifying that the computed distance is comprised in a range of acceptable distances for the system, and when it is not the case, notifying the user of the error.
displaying on the screen of the calibration device at least the image captured by the camera of the calibration device, a picture indicating where the user should aim and a message instructing the user to target the centre of the display device, displaying on the screen of the display device, at the centre of the screen, at least a picture indicating where the user should aim at, obtaining validation from the user when pointing towards the centre of the display device, measuring the azimuth and elevation angles of the centre of the display device and setting the azimuth and elevation angles of the centre of the display device as reference angles for further loudspeaker angle measurements.
verifying that the device is held in upright position, the verification comprising checking that the absolute value of the roll angle obtained from the sensors is below a threshold; and if the verification succeeds, enabling the user validation means, if the verification fails, disabling the user validation means and displaying indications to help recover the upright position.
providing at least one of the azimuth and elevation angles to the processor of the audio processing device configured to verify that the measured angles are comprised in a range of acceptable values for the loudspeaker, and in case at least one measured angle is outside the range of acceptable values for the loudspeaker, notify the user of the error.

In a third aspect, the disclosure is directed to a system for detecting loudspeaker connection errors and positioning errors in a multichannel audio setup comprising an audio processing device configured at least to provide a test tone audio signal to a loudspeaker, a set of loudspeakers configured to render the test tone audio signal, and a calibration device configured to measure the azimuth and elevation angles of each loudspeaker, verify that the measured angles are comprised in a range of acceptable values for the loudspeaker, and when it is not the case, notify the user of the error;

In a fourth aspect, the disclosure is directed to a computer program comprising program code instructions executable by a processor for implementing any embodiment of the method of the first aspect.

In a fifth aspect, the disclosure is directed to a computer program product which is stored on a non-transitory computer readable medium and comprises program code instructions executable by a processor for implementing any embodiment of the method of the first aspect.

### BRIEF DESCRIPTION OF DRAWINGS

Preferred features of the present disclosure will now be described, by way of non-limiting example, with reference to the accompanying drawings, in which:

FIG. 1A illustrates an example calibration device according to the present principles;

FIG. 1B illustrates an example audio processing device according to the present principles;

FIG. 2 illustrates an example interconnection between the devices in the preferred implementation of the disclosure in a 5.1.2 loudspeaker setup;

FIG. 3 represents a top view of an example setup of a listening room corresponding to a 5.1.2 configuration;

FIGS. 4A, 4B, 4D and 4E depict flowcharts describing steps implementing the disclosure;

FIG. 4C illustrates an example of azimuth angles used for the distance computation;

FIG. 5A illustrates an example of a user interface displayed on the screen of the calibration device while measuring the angle for one loudspeaker, wherein the calibration device horizontality is verified and not yet in the acceptable range since the user does not hold the device in the upright position;

FIG. 5B illustrates an example of a user interface displayed on the screen of the calibration device while measuring the angle for one loudspeaker, wherein the device is held in upright position; and

FIG. 6 illustrates an example of top-down view showing loudspeaker position and the acceptable azimuth angle range for a configuration comprising seven speakers.

### DESCRIPTION OF EMBODIMENTS

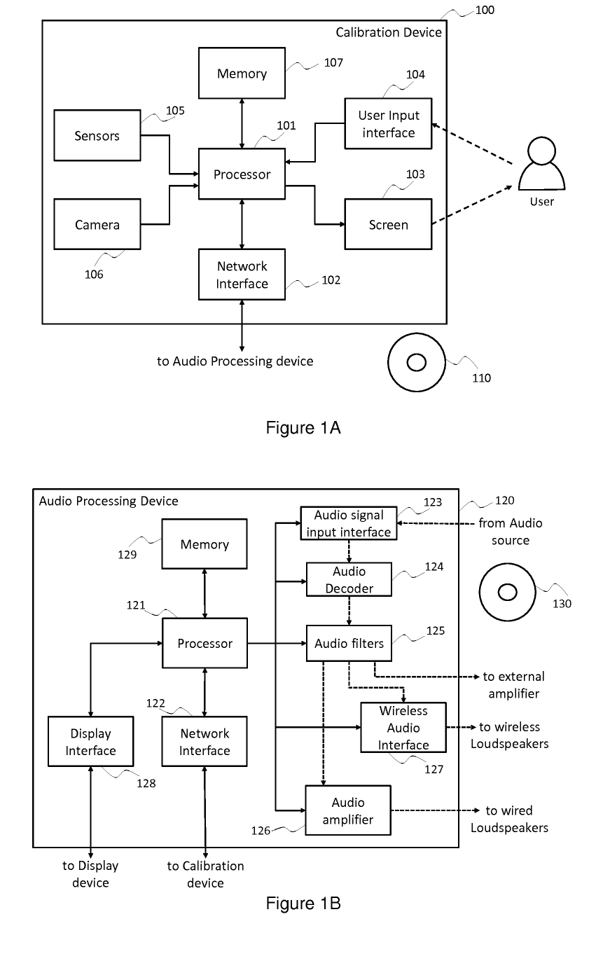

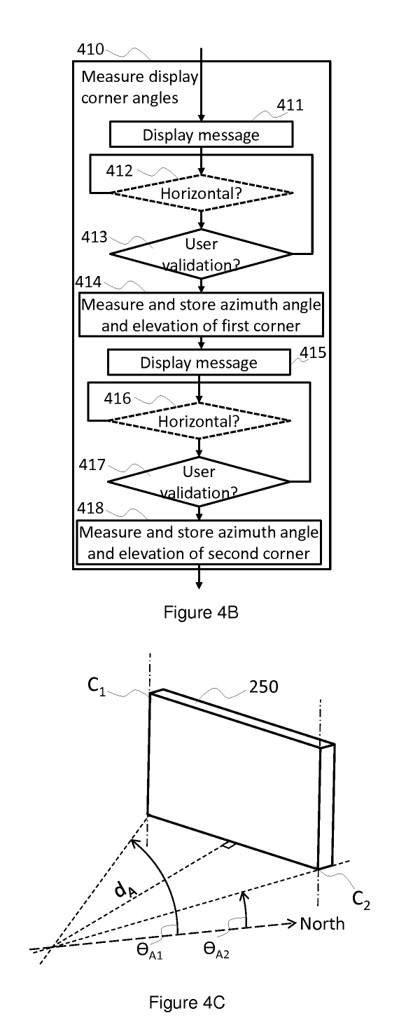

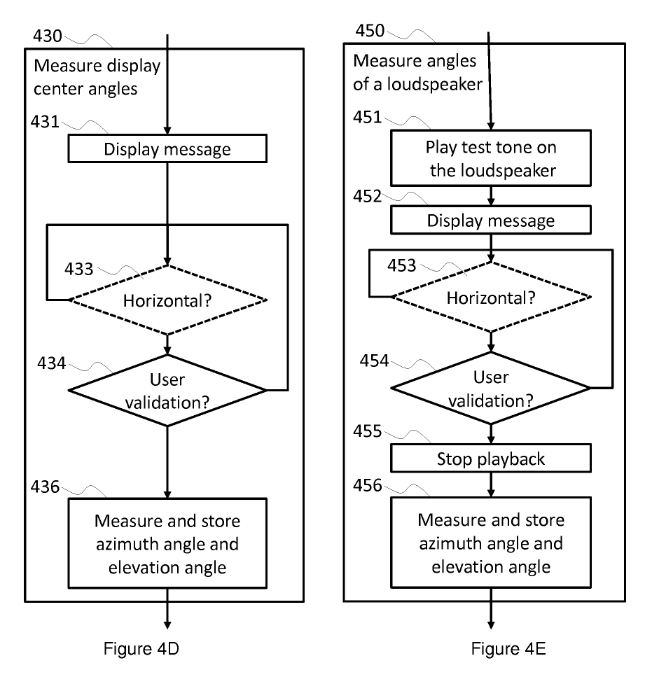

FIG. 1A illustrates an example calibration device 100 according to the present principles. The skilled person will appreciate that the illustrated device is simplified for reasons of clarity. According to a specific and non-limiting embodiment of the principles, the calibration device 100 preferably comprises at least one hardware processor 101 configured to execute the method of at least one embodiment of the present disclosure, a network interface 102 configured to interact with other devices such as audio processing device (120 in FIG. 1B), a screen 103 configured to interact with the user by displaying information at least related to the calibration application, a user input interface 104 configured to received input from the user, sensors 105 configured to measure parameters related to the position of the calibration device 100, a camera 106 configured to provide images captured by the camera lens not depicted in the figure, and a memory 107 configured to store at least the results of the measures performed on the device environment. A non-transitory computer readable storage medium 110 stores computer readable program code comprising at least a calibration application that is executable by the processor 101 to perform the calibration operation according to the method described in FIG. 4A.

One example of calibration device is a smartphone. Another example of calibration device is a tablet. Many other such calibration devices may be used, consistent with the spirit of the disclosure.

Conventional communication interfaces such as Wifi or Bluetooth constitute examples of network interface 102. Other network interfaces may be used, consistent with the spirit of the disclosure. These network interfaces may provide support for higher level protocols such as various Internet protocols, data exchange protocols or device interoperability protocols such as AllJoin in order to allow the calibration device 100 to interact with the audio processing device 120.

A touch interface is one example of user input interface. A keyboard is another one. Many other such user input interfaces may be used, consistent with the spirit of the disclosure.

Sensors 105 comprise at least rotational vector sensors and a magnetometer. These sensors are conventionally comprised in smartphones and tablets, such devices being representative examples of calibration devices. The person skilled in the art will appreciate that such a combination of sensors allows to determine the orientation of the device in a reference three axis coordinate system. In the disclosure, the device is preferably held upright; the screen surface being nearly perpendicular to the floor, in front of the user's eyes. When a device is held in such a position, the X axis is horizontal and points to the right, the Y axis is vertical and points up, and the Z axis points toward the user, out of the screen. In this system, coordinates behind the screen have negative Z values. In the disclosure, the elevation angle corresponds to rotations around the X axis, the azimuth angle corresponds to rotations around the Y axis and the roll angle corresponds to rotations around the Z axis. The combination of sensors provides azimuth, elevation and roll angles of the calibration device in the reference three axis coordinate system.

FIG. 1B illustrates an example audio processing device 120 according to the present principles. The skilled person will appreciate that the illustrated device is simplified for reasons of clarity. According to a specific and non-limiting embodiment of the principles, the audio processing device 120 comprises at least one hardware processor 121 configured to execute the method of at least one embodiment of the present disclosure, a network interface 122 configured to interact with other devices such as calibration device 100, an Audio signal input interface 123 configured to receive the audio signal to be rendered to the listener, the Audio decoder 124 configured to decode the audio signal, a set of Audio Filters 125 configured to adjust the decoded audio signal according to the calibration parameters determined for each loudspeaker, a set of Audio amplifiers 126 configured to amplify the audio signal in order to deliver the amplified decoded signal to the loudspeakers, a wireless audio interface 127 configured to provide wirelessly the decoded audio signal to a wireless amplified loudspeaker 140, a display interface 128 configured to deliver a video signal to an external display device such as a television or monitor and a memory 129 configured to store at least the calibration parameters for each loudspeaker. The decoded audio signal is also directly available on a connector in order to be rendered by an external amplifier or a (wired) amplified loudspeaker, which is generally the case for subwoofers. A non-transitory computer readable storage medium 130 stores computer readable program code comprising at least a calibration application that is executable by the processor 121 to perform the calibration operation according to the method described in FIG. 4A.

In a preferred embodiment, the input source comes from an external device. Multiple different devices are able to provide an audio signal, including a cable receiver, a satellite receiver, any means to receive digital television including “over-the-top” devices well-known by the skilled in the art, a mass storage device such as a USB external hard disk drive or USB key. The audio signal can also be delivered through the Internet through streaming mechanisms using appropriate network connection and protocols.

In a variant, the audio processing device 120 not only handles audio but also video. In this case, in addition to the modules described in FIG. 1B, an additional demultiplexer module splits the incoming signal to separate the audio from the video. The audio signal is handled as described above. The video signal is decoded by an appropriate video decoder and provided to the display interface. In another variant, the audio processing device 120 integrates also the front end module allowing the reception of a broadcast signal and therefore providing the audio signal, such front end module comprising at least one of a cable tuner, a satellite tuner, and an Internet gateway.

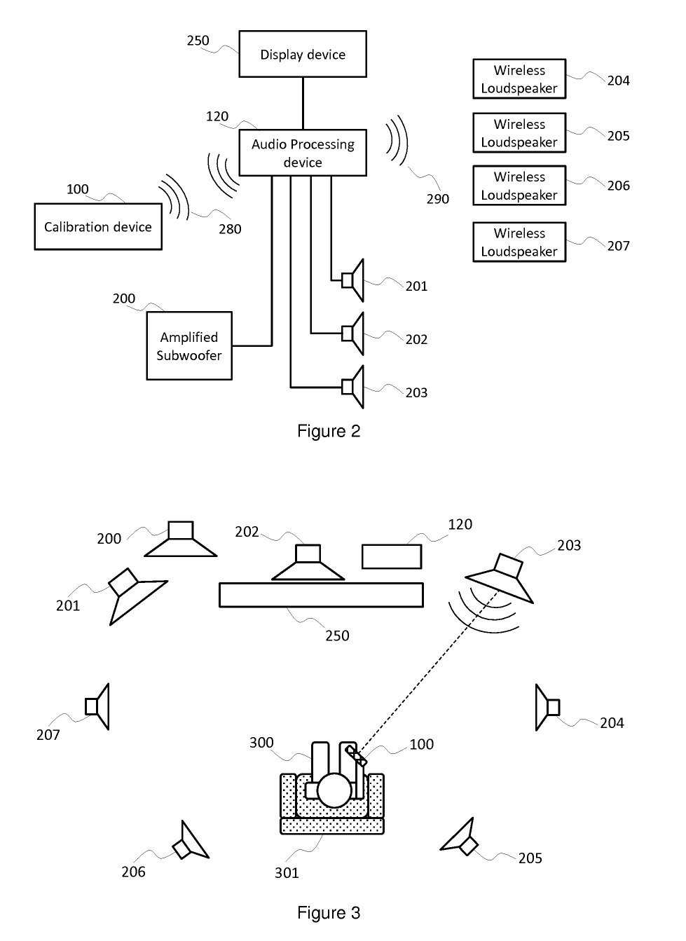

FIG. 2 illustrates an exemplary interconnection between the devices of the preferred implementation of the disclosure in a 7.1 loudspeaker setup. The calibration device 100 is connected to the audio processing device 120 through network connection 280. A set of loudspeakers 201, 202, 203 are connected to the audio processing device 120 and are taking benefit of the integrated amplifier. An amplified subwoofer 200 is connected to the audio processing device 120 through a non-amplified connection. Wireless loudspeakers 204, 205, 206 and 207 are connected wirelessly to the audio processing device 120. Wireless loudspeakers comprise a wireless audio interface configured to receive the audio signal through a wireless carrier and deliver the audio signal to an audio amplifier configured to amplify the audio signal and deliver it to the loudspeaker that will generate the sound waves corresponding to the incoming audio signal. The person skilled in the art will appreciate that both the network connections and the loudspeaker connections can either be wired or wireless and many different combination of wired and wireless are possible. In a preferred embodiment, the network connection 280 uses Bluetooth while the wireless Loudspeaker connections use a proprietary solution in the 2.4 GHz band carrying uncompressed audio. Other types of networks may be used while keeping consistent with the spirit of the invention. For instance Bluetooth with A2DP profile (Advanced Audio Distribution Profile) could also be used.

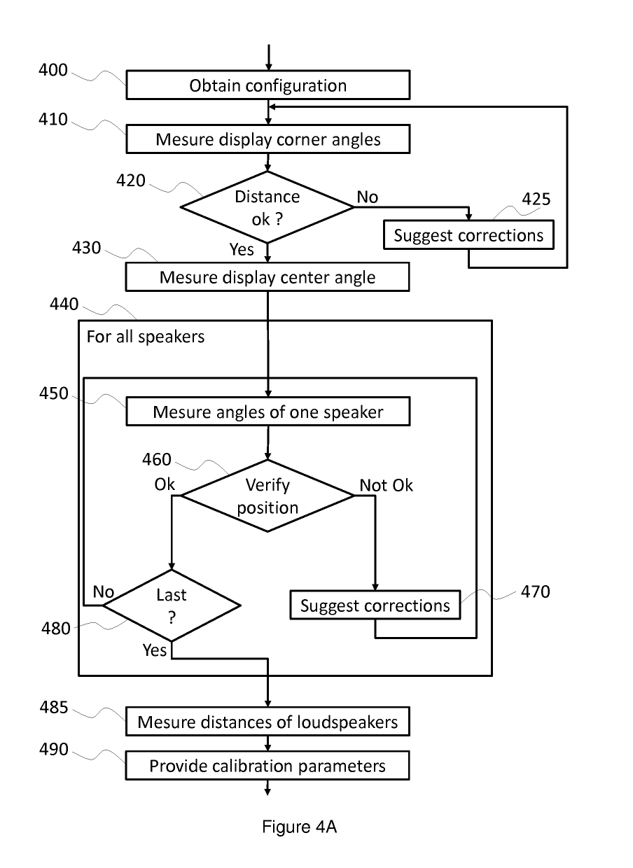

FIG. 3 represents a top view of an exemplary setup of a listening room corresponding to a 5.1.2 configuration. The listening room is equipped with an audio processing device 120, a display device 250 and a set of loudspeakers 200, 201, 202, 203, 204, 205, 206, 207. A user 300 is sitting on a couch 301, using a smartphone as calibration device 100. The figure illustrates one step of the calibration phase where the test tone is played back by the audio processing device 120 on loudspeaker 203. The user hears the sound coming from the loudspeaker 203 and orients his smartphone so that the integrated camera points towards the loudspeaker 203. Further operations are described in the next paragraphs.

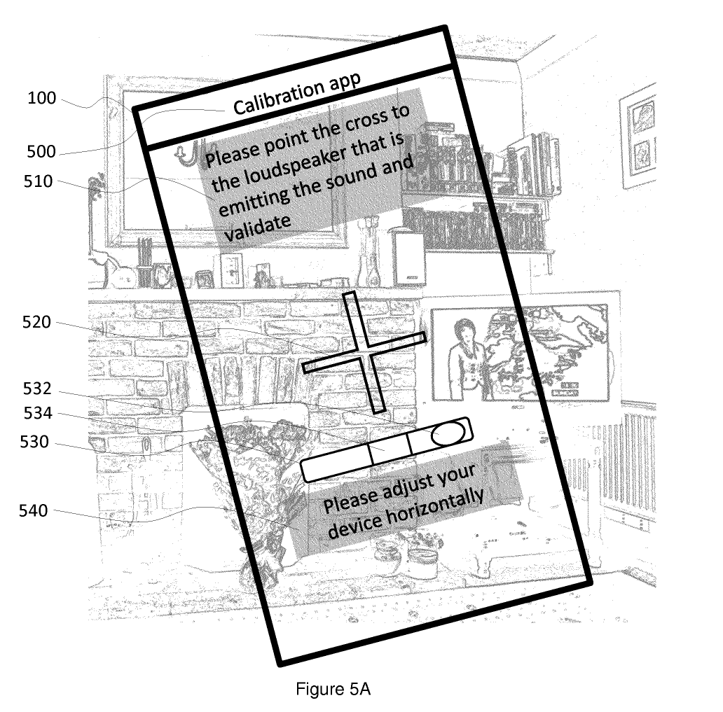

FIGS. 4A, 4B, 4D and 4E depict flowcharts describing steps required to implement the disclosure. Prior to these steps, the calibration application is launched on the calibration device 100. Through a message displayed on the calibration device, the user is requested to position itself at the listening position, for example sitting on the couch 301. The application actives the camera 107 of the calibration device 100, therefore displaying on the screen 103 of the calibration device 100 the image captured by the camera. This image represents the scene in front of the calibration device 100. A graphical element is preferably overlaid onto the image from the camera to represent the element of the captured scene aimed by the calibration device, as represented by a cross 520 in FIG. 5A.

An overview of the complete steps is first provided by the description of FIG. 4A and the details will be introduced in further paragraphs describing FIGS. 4B, 4D and 4E. In step 400 of FIG. 4A, the configuration is obtained including the number of loudspeakers connected to the audio processing device 120 as well as the size (diagonal) of the screen of the display device 250 connected to it. In step 410, the azimuth and elevation angles of the display device's corners are measured. Knowing the size of the screen of the display device 250, the calibration device is then able to determine the viewing distance, check if this distance is correct, in step 420, and suggest corrections, in step 425, when the viewing distance is incorrect. For example, when the distance is smaller than a threshold, the user is asked to increase the distance. The threshold is determined according to conventional rules well known by the person skilled in the art. When the distance is correct, in step 430, the azimuth and elevation angles of the centre of the TV are measured. This measure will be taken as reference for all loudspeaker angle measurements. An iteration is then started for all loudspeakers. In step 450, the azimuth and elevation angles of the first loudspeaker are measured.

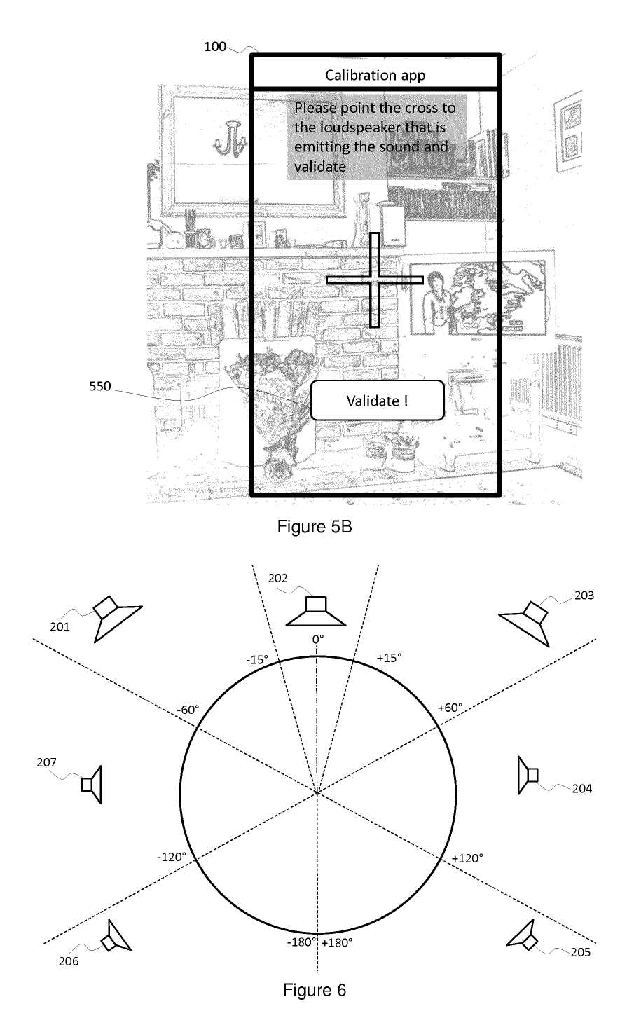

In step 460, it is verified if the azimuth and elevation angles correspond to a correct position for this loudspeaker. This is done using position ranges illustrated in FIG. 6A and the corresponding range of angles for each loudspeaker listed in table 6B. When the angle measured for a loudspeaker matches the interval range for this loudspeaker, it is considered as valid. When it does not match, the position is considered as incorrect. In the case the measurement corresponds to the previous or next loudspeaker in the table illustrated in FIG. 7B, then it can be considered as a position error since the loudspeaker position is close to its interval range position. However, if the difference is greater than that, then it is probably a wiring error. Indeed, it is very easy to make wiring errors when laying down under a furniture, in the dark, trying to connect a cable onto a connector, or to make a mistake while associating a wireless loudspeaker. Some corrections are suggested by displaying a message to the user, in step 470. If a position error is suspected, then the message contains indications of the direction in which the loudspeaker should be moved. If a wiring error is suspected, then the message contains indications of the wirings to verify. For example, when measuring the angle for the front left loudspeaker 201, if the angle measured correspond to the rear left loudspeaker 206, then the message indicates that “there might be a wiring error between the front right and the rear right loudspeakers”. After displaying such an error message, the calibration device requests the user to measure the angle for that same loudspeaker again, restarting from step 450.

In step 480, it is checked if all angles have been measured. If it is not the case, the calibration device 100 continues the measures, in step 450, with the next loudspeaker. When all angle measurements have been done, the distance of the loudspeakers are then measured, in step 485. These measurements are well known by the skilled in the art. For example, a test tone is successively provided to each loudspeaker at a given level of power. The calibration device 100 captures the test tones through the integrated audio microphone 123, measures the power level of each captured test tone and determines the distance to each loudspeaker according to the transfer function of the microphone. In step 490, the calibration parameters are provided to the audio processing device 120, allowing this device to setup the audio filters 125 for each loudspeaker. The plurality of audio input channels are distributed over the plurality of loudspeakers according the positions of each loudspeaker (angle and distance), by performing interpolation between multiple inputs to render correctly the complete three-dimensional sound. Especially when the room configuration prevents to position the loudspeaker in the appropriate area, the rendering of the audio channel is adapted for example by using vector based amplitude panning techniques based on the angular position measured for the loudspeakers.

In the preferred embodiment, the step 400 of obtaining the configuration is not performed since the configuration is known in advance so that the user installed on his calibration device 100 the calibration application corresponding exactly to the setup configuration. For example, this application can be specially configured by the device provider when the user buys the devices.

FIG. 4B details step 410. In this step, the angles of the corners of the display device are measured. In step 411, a message is displayed to request the user to point to a first corner (for example the upper left) of the screen of the display device 250 that is connected to the audio processing device 120 and to validate when pointing to this first corner. In order to make precise angle measurements, the user is guided by a graphical element overlaid onto the image from the camera to indicate the single point that is aimed. A cross, a target, perpendicular axis, or a set of concentric circles located at the centre of the screen are examples of such a graphical element. The user is therefore able to align this graphical element with the first corner of the audio processing device 120. In optional step 412, it is checked if the user holds his device in upright position. Performing all measurements while holding the calibration device in upright position increases the precision of the measurements. This verification is performed using data provided by the integrated sensors 105 of the calibration device and more precisely by verifying the value of the roll angle measuring rotations around the Z axis that is perpendicular to the screen. The absolute value of the roll angle should be lower than a threshold value. For example, a threshold value of 1° provides a good precision but can be tedious to achieve for the user. A threshold value of 30° would be easier to achieve but provides less accuracy. A threshold value of 5° is a good compromise between usability and precision. In order to facilitate the interaction for the user, the roll angle is represented on the screen of the calibration device, either directly by its absolute numerical value, or represented by arrows indicating in which direction the device must be rotated, or represented by a bubble level indicating the horizontality, as depicted in FIG. 5A. In the preferred embodiment, the result of this verification enables the validation button, so that it is impossible to go to further steps while the user does not hold the calibration device in upright position. In step 413, the method waits for user validation. When the user validation is received, in step 414, the azimuth angle and elevation angle of the first corner are measured and stored in memory 107. In steps 415, 416, 417 and 418, the process is repeated for the second corner of the screen, for example the bottom right corner. With these angle measurements and the size of the screen (e.g. its diagonal), the calibration device is able to approximate the distance between the display device 250 and the listening position, for example using the azimuth angles as follows:

$${d}_{A} = \frac{\sqrt{\frac{{D}^{2}}{1 + \frac{{9}^{2}}{{16}^{2}}}}}{2 \times tan ( \frac{\vert {θ}_{A 1} - {θ}_{A 2} \vert}{2} )}$$

Where D is the diagonal of the screen of the display device, assuming the screen has a 16/9 aspect ratio, θ_{A1} is the azimuth angle measure for first corner and θ_{A2} is the azimuth angle measure for second corner. FIG. 4C illustrates an example of azimuth angles used for the distance computation. C1 and C2 are the corners of the display device 250 aimed successively by the user. The angles related to these corners are respectively θ_{A1} and θ₄₂, being the projections of the corner on a horizontal line and measured towards the north direction. The computation above makes the assumption that the listening position is nearly centred regarding the middle of the screen.

The same distance calculation can be done using the elevation angles with same hypothesis:

$${d}_{E} = \frac{\sqrt{\frac{{D}^{2}}{1 + \frac{{16}^{2}}{{9}^{2}}}}}{2 \times tan ( \frac{\vert {θ}_{E 1} - {θ}_{E 2} \vert}{2} )}$$

Both distance calculations can then be averaged to determine the distance to the listener and so that the value of the distance between the display device 250 and the listening position is equal to

$$\frac{{d}_{A} + {d}_{E}}{2} .$$

FIG. 4D details step 430. In this step, the azimuth and elevation angles of the centre of the screen of the display device are measured. In step 431, a message is displayed to request the user to point to the centre of the screen of the display device 250 that is connected to the audio processing device 120 and to validate when pointing to the centre of the screen. Similarly to above, this pointing operation is performed by aligning the graphical element displayed on the screen of the calibration device with the centre of the screen of the display device. Preferably, the audio processing device 120 delivers an image to the display device 250 through the display interface 128 in order for the user to identify clearly the centre of the screen. This image can for example take the same form as the graphical element displayed on the screen of the calibration device or any other form in which the centre of the screen is easily identifiable. Therefore, pointing to the centre of the display device screen is done by aligning the graphical element displayed on the screen of the calibration device with the graphical element representing the centre of the screen of the display device and displayed on the display device. In optional step 433, it is checked if the user holds his device in upright position, as discussed previously. In step 434, the method waits for user validation. In step 436, the azimuth angle and elevation angle are measured and stored in memory 107. These angles represent the viewing axis of the user and define the reference axis for the three-dimensional system. All angles further measured will be transposed according this reference model. For example, if the azimuth angle measured for the screen centre is +42°, then this value of 42° is subtracted from all subsequently measured values in order to compare these values with the acceptable range of angles defined in table of FIG. 6B, wherein the reference is set to 0°. In the case a relative angle measurement system is used, then the angle of the screen centre will be the initial reference angle.

FIG. 4E details step 450. In this step, the angles of a loudspeaker are measured. This step is iterated for all loudspeakers composing the audio setup. In step 451, a test tone is emitted on the loudspeaker whose angles will be measured. In step 452, a message is displayed to request the user to point to the centre of the loudspeaker emitting the sound and to validate when pointing to the loudspeaker. Similarly to above, this pointing operation is performed by aligning the graphical element displayed on the screen of the calibration device with the centre of the loudspeaker. In optional step 453, it is checked if the user holds his device in upright position, as discussed previously. In step 454, the method waits for user validation. When user validation is received, in step 455, the playback of the test tone is stopped. In step 456, the azimuth angle and elevation angle are measured and stored in memory 107. These angles represent the direction from the listening position towards the loudspeaker in the three-dimensional system.

In a variant embodiment, the messages displayed on the screen of the calibration device 100 (for example in steps 411, 415, 431, 451) are also preferably displayed on the display device 250. The message or image to be displayed can either be provided by the calibration device 100 to the audio processing device 120 through the network connection 280 or can be generated directly by the audio processing device. The image or message is then delivered by the audio processing device 120 to the display device 250 through the display interface 128.

The person skilled in the art will appreciate that in the case the user no more answers to solicitations of the calibration device 100, the calibration process is automatically stopped and the playback of the test tone is stopped. Such situation is detected by a timeout at the steps 412, 413, 416, 417, 433, 434, 453 and 454, steps for which an input from the user is requested.

The calibration process requires the use of audio test tones. In a preferred embodiment, the test tones are stored in the calibration device 100, for example under the form of an audio file. In this case, when the calibration application needs to playback the test tones, the test tones are first read by the calibration device 100, converted into a corresponding audio signal that is provided to the audio processing device 120 through the network connection 280. The audio processing device 120 amplifies this audio signal and delivers it to the loudspeaker that transforms the signal into the corresponding sound waves. In a second embodiment the test tones are stored in the calibration device 100, for example in the form of an audio file. In this case, when the calibration application needs to playback the test tones, the calibration device 100 requests the audio processing device 120 to start the playback. This is done by sending a dedicated command on the network connection 280. This command indicates on which loudspeaker the sound needs to be output. Upon reception of this command, the audio processing device 120 reads the test tone, converts it into a corresponding audio signal. This signal is either amplified and delivered to the designated loudspeaker that transforms the signal into the corresponding sound waves, or output on a connector toward an amplified loudspeaker or sent through wireless audio communication means toward a wireless amplified loudspeaker. In the two latter cases, the received signal is amplified directly by the device and delivered to the integrated loudspeaker that transforms the signal into the corresponding sound waves. Another command is dedicated to stop the playback. In variants of both embodiments, the test tones are generated rather than being read, by using a software or hardware signal generator.

FIG. 5A illustrates an example of user interface displayed on the screen of the calibration device while measuring the angle for one loudspeaker, wherein the calibration device horizontality is verified and not yet in the acceptable range since the user does not hold the device in the upright position. The calibration application is launched on the calibration device 100 and displays the following elements on the screen of the calibration device: a title bar 500, an instruction message 510 to the user, a cross 520 to symbolize the target of the measure, a bubble level 530 to represent the horizontality, comprising a bubble 532 that moves according the level of horizontality and an area 534 representing the target horizontality level to be achieved and a warning message 540 to indicate that the device needs to be rotated.

FIG. 5B illustrates an example of user interface displayed on the screen of the calibration device while measuring the angle for one loudspeaker, wherein the device is held the upright position. In this case, the bubble level is no more displayed and is replaced by a validation button 550 that triggers the measure of the angles. The person skilled in the art will appreciate that other techniques can be used to obtain validation from the user such a vocal command or gesture detection.

FIG. 6 illustrates an example of top-down view showing the loudspeaker positioning and the azimuth angle range acceptability for a configuration comprising seven speakers. The reference angle is the angle measured for the centre of the screen and therefore is referenced as the 0° angle. Angles increase from the reference clockwise up to +180° and decrease anti-clockwise up to −180°. In this example, all loudspeakers are placed correctly. Similar considerations apply to elevation angles since some loudspeakers must be positioned above the listener.

Table 1 lists the azimuth angle range acceptability for a configuration comprising seven speakers, as depicted in FIG. 6. The minimal and maximal angle value is determined for each loudspeaker of the configuration, with regards to the reference angles of the centre of the display device. All angles measured must be transposed in that reference system, before being compared to the values of table 1, in step 460 of the sequence diagram of FIG. 4A. This transposition is done by subtracting to the angle values the values of the angles measured for the centre of the display device. For example, if the measured azimuth angle of the display device is 42°, then a measured azimuth angle of 59° for a loudspeaker results in an azimuth angle value of 17° in the table 1, therefore corresponding to a front right speaker.

TABLE 1
Azimuth angle range acceptability

| Loudspeaker | Minimal azimuth angle | Maximal azimuth angle |
|---|---|---|
| Center | −15° | +15° |
| Front Left | −60° | −15° |
| Front Right | +15° | +60° |
| Mid Left | −120° | −60° |
| Mid Right | +60° | +120° |
| Rear Left | −180° | −120° |
| Rear Right | +120° | +180° |

In the preferred embodiment, all verifications as well as the determination of the audio parameters are performed in the calibration device 100. In an alternate embodiment, the determination of the audio parameters is computed in the audio processing device 120. Such embodiment further comprises providing the appropriate data from the calibration device 100 to the audio processing device 120.

In another embodiment, the messages instructing the user to target a loudspeaker, a corner of the display device are displayed on the display device, either in addition or in replacement of the display on the calibration device.

In another embodiment, the calibration device does not comprise a camera and a screen but comprises a laser pointer able to project a concentrated light beam that for example results into a red point when hitting an object. Such solution also allows to aim at the loudspeakers without requiring the use of a camera and screen. In this case, the messages instructing the user to target a loudspeaker or a corner of the display device are displayed on the display device. The other features of such a calibration device are identical to the calibration device described here above.

As will be appreciated by one skilled in the art, aspects of the present principles can take the form of an entirely hardware embodiment, an entirely software embodiment (including firmware, resident software, micro-code and so forth), or an embodiment combining hardware and software aspects that can all generally be defined to herein as a “circuit”, “module” or “system”. Furthermore, aspects of the present principles can take the form of a computer readable storage medium. Any combination of one or more computer readable storage medium(s) can be utilized. It will be appreciated by those skilled in the art that the diagrams presented herein represent conceptual views of illustrative system components and/or circuitry embodying the principles of the present disclosure. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

1. A method for detecting loudspeaker connection errors and positioning errors in a multichannel audio system comprising an audio processing device, a set of loudspeakers, and a calibration device, comprising at a processor of the calibration device:
for at least one loudspeaker, measuring at least one of an azimuth angle and an elevation angle of the loudspeaker in a three-dimensional coordinate system when a test tone is played on the loudspeaker, the measuring comprising:
displaying on a screen of the calibration device at least an image captured by a camera of the calibration device and an overlaid picture indicating where to aim; and
obtaining validation when the calibration device is aimed at the loudspeaker, aligning on the screen of the calibration device the overlaid picture with the captured image of the loudspeaker;
verifying that the measured angles are comprised in a range of acceptable values for the loudspeaker, and
in case at least one measured angle is outside the range of acceptable values for the loudspeaker, notifying a user of an error.

2. The method according to claim 1 further comprising displaying a message instructing the user to aim at the loudspeaker emitting the test tone.

3. The method according to claim 1 further comprising:
displaying on the screen of the calibration device at least an image captured by the camera of the calibration device, an overlaid picture indicating where to aim and a message instructing the user to target a first corner of a display device;
obtaining validation from the user when pointing towards the first corner;
measuring the azimuth and elevation angles of the first corner;
displaying on the screen of the calibration device the image captured by the camera of the calibration device, an overlaid picture indicating where the user should aim and a message instructing the user to target a second corner of the display device, the second corner being the corner opposite to the first one;
obtaining validation from the user when pointing towards the second corner;
measuring the azimuth and elevation angles of the second corner;
computing the distance between the calibration device and the display device; and
verifying that the computed distance is comprised in a range of acceptable distances for the system, and when it is not the case, notifying the user of the error.

4. The method according to claim 1 further comprising:
displaying on the screen of the calibration device at least an image captured by a camera of the calibration device, an overlaid picture indicating where to aim and a message instructing to aim at the centre of the display device;
displaying on the screen of the display device, at the center of the screen, at least a picture indicating where the user should aim at;
obtaining validation from the user when pointing towards the center of the display device;
measuring the azimuth and elevation angles of the center of the display device;
setting the azimuth and elevation angles of the center of the display device as reference angles for further loudspeaker angle measurements.

5. The method according to claim 1 further comprising:
verifying that the device is held in upright position, the verification comprising checking that the absolute value of the roll angle obtained from at least one of the sensors of the calibration device is below a threshold; and:
if the verification succeeds, enabling user validation means;
if the verification fails, disabling the user validation means and displaying indications to help recover the upright position.

6. The method according to claim 1 wherein the message displayed on the screen of the calibration device is also displayed on the display device.

7. The method according to claim 1 wherein the processor of the calibration device is configured to provide at least one of the azimuth and elevation angles to the processor of the audio processing device, configured to verify that the measured angles are comprised in a range of acceptable values for the loudspeaker, and in case at least one measured angle is outside the range of acceptable values for the loudspeaker, notify the user of the error.

8. A calibration device for performing angular measurement of loudspeaker angular positions, verifications of these positions according to a range of acceptable positions and interactions with a user in a multichannel audio system, comprising:
a network interface configured to request a loudspeaker to play back a test tone;
a camera configured to capture images representing a scene in front of the device;
at least one sensor configured to determine azimuth, elevation and roll angles of the device;
a screen configured to display at least an image captured by the camera, an overlaid picture indicating where the user should aim and a message instructing the user what element to target;
a user input interface configured to obtain validation from the user when the calibration device is aimed at the loudspeaker, aligning on the screen of the calibration device the overlaid picture with a captured image of the loudspeaker;
a processor configured to, for each loudspeaker:
after obtaining validation, measure at least one of the azimuth and elevation angles of the loudspeaker in a three-dimensional coordinate system when the test tone is played on the loudspeaker;
verify that the measured angles are comprised in a range of acceptable values for the loudspeaker, and
in case at least one measured angle is outside the range of acceptable values for the loudspeaker, notify the user of the error.

9. The calibration device according to claim 8 wherein the processor is further configured to:
display on the screen at least an image captured by the camera, an overlaid picture indicating where the user should aim at and a message instructing the user to target a first corner of a display device;
obtain validation from the user when pointing towards a first corner of the display device;
obtain azimuth and elevation angles of the direction towards first corner of the display device from the sensors;
display on the screen at least an image captured by the camera, an overlaid picture indicating where the user should aim at and a message instructing the user to target a second corner of the display device, the second corner being the corner opposite to the first one;
obtain validation from the user when pointing towards the second corner of the display device;
obtain azimuth and elevation angles of the direction towards second corner of the display device from the sensors;
compute the distance between the calibration device and the display device; and
verify that the computed distance is comprised in a range of acceptable distances for the system, and when it is not the case, notify a user of an error.

10. The calibration device according to claim 8 wherein the processor is further configured to:
verify that the calibration device is held in upright position, the verification comprising checking that the absolute value of the roll angle obtained from the sensors is below a threshold; and:
if the verification succeeds, enable the user validation means;
if the verification fails, disable the user validation means and display indications to help recover the upright position.

11. The calibration device according to claim 8 wherein the processor is further configured to provide at least one of the azimuth and elevation angles to the processor of the audio processing device configured to verify that the measured angles are comprised in a range of acceptable values for the loudspeaker, and in case at least one measured angle is outside the range of acceptable values for the loudspeaker, notify a user of an error.

12. A system for detecting loudspeaker connection errors and positioning errors in a multichannel audio setup comprising:
an audio processing device configured at least to provide a test tone audio signal to each loudspeaker, one after the other;
a set of loudspeakers configured to render the test tone audio signal;
a calibration device configured to:
for at least one loudspeaker, measure at least one of an azimuth angle and an elevation angle of the loudspeaker in a three-dimensional coordinate system when a test tone is played on the loudspeaker, the measurement comprising:
displaying on a screen of the calibration device at least an image captured by a camera of the calibration device, an overlaid picture indicating where a user should aim and a message instructing the user to aim at the loudspeaker emitting the test tone; and
obtaining validation from the user when the calibration device is aimed at the loudspeaker, aligning on the screen of the calibration device the overlaid picture with the captured image of the loudspeaker;
verify that the measured angles are comprised in a range of acceptable values for the loudspeaker, and
in case at least one measured angle is outside the range of acceptable values for the loudspeaker, notify a user of an error.

13. Computer program comprising program code instructions executable by a processor for implementing the steps of a method according to claim 1.

14. Computer program product which is stored on a non-transitory computer readable medium and comprises program code instructions executable by a processor for implementing the steps of a method according to claim 1.
